(19) United States
(12) Patent Application Publication
(10) Pub. No.: US 2005/0061195 A1
(43) Pub. Date: Mar. 24, 2005

(54) Conveying device

(76) Inventors: Heinrich Lutz, Dirlewang (DE); Peter Steger, Bad Worishofe (DE); Hinrich Stave, Mindelheim (DE)

Correspondence Address: JACOBSON, PRICE, HOLMAN & STERN;PROFESSIONAL LIMITED LIABILITY COMPANY, 400 Seventh Street, N.W., Washington, DC, 20004, US

(21) Appl. No.: 10/731,485

(22) Filed: Dec. 10, 2003

(30) Foreign Application Priority Data
Dec. 12, 2002 (DE) 102 58 328.5
Jul. 18, 2003 (DE) 103 32 689.8

(51) Int. Cl. B23Q 7/14; B23Q 5/28

(52) U.S. Cl. 104/290

(57) ABSTRACT

The invention refers to a conveying device for a production or machining line with at least one, in particular cutting, machining station. The conveying device serves for conveying workpieces by means of conveying aids, like pallets or workpiece carriers, a primary part of a linear motor being provided along the conveying path which creates a magnetic field, and the conveying aid being formed by the secondary part of the linear motor.

The invention refers to a conveying device for a production or machining line with at least one, in particular, cutting machining station.

### BACKGROUND OF THE INVENTION

The conveying of workpieces between production installations (cutting machines and assembly machines) is carried out mainly by means of electrically driven rollers and/or chains. This design of the conveying of workpieces between the production installations still requires here a plurality of mechanic production parts, for the conveying between the production installations as well as in each production installation itself. Furthermore another pull-in device is necessary in order to make the actual change of workpieces within the machine possible.

Other conveying devices are known in the state of the art, as they are used, for example, for the transport of pieces of luggage, for example in airports. Here, according to this known solution, long-stator linear motors with a primary part extending over the complete line and a reaction part each arranged on each conveying element are used.

Also a machine tool is known which has a machine stand on which along a movement axis a machine unit which can be driven is arranged. This solution is also characterised by a linear motor in a long-stator construction where the complete length (measured in the direction of movement) of the primary part(s) arranged in one plane is larger than the complete length of the assigned secondary part(s). By means of this solution, however, only workpieces are fed, respectively conveyed, on the machine tool itself. The conveying of very different workpieces, as it is, for example, necessary in production, respectively machining, lines, cannot be realised with such a solution.

### BRIEF SUMMARY OF THE INVENTION

Coming from the described state of the art it is an object of the invention to provide a solution which carries out the conveying jobs for workpieces in a production or machining line with considerably less effort.

The invention comes from the state of the art mentioned before and proposes a conveying device for a production or machining line with at least one, in particular cutting, machining station, the conveying device serving for the conveying of workpieces with conveying aids, like pallets or workpiece carriers, along the conveying path a primary part of a linear motor being provided which creates a magnetic field, and the conveying aid is formed by the secondary part of the linear motor.

By means of such a solution it is now possible to equip a production and machining line comprising at least one, in particular cutting, machining station with a convenient and interference resistant conveying device which manages with a considerably smaller mechanic equipment for these conveying devices, and which makes it simultaneously possible to convey the workpieces between the separate machining stations as well as to supply and position the workpieces in the machining station.

According to a convenient development of the solution according to the invention it is accordingly provided that the conveying device serves for a conveying of the workpieces between the different machining stations as well as for a positioning of the workpiece in the machining station.

Another aspect of the invention is given by the fact that the conveying device serves also for a movement of the workpiece in the machining station during machining. By means of that additional expenses can be saved which have been necessary, for example, according to the state of the art for the embodiment of clamping devices which can be moved in the station. It is possible here without any problems to design the linear drive accordingly so that a highly accurate machining is possible in the machining station.

A development of the conveying device according to the invention is characterised by the fact that the primary part creating the magnetic field is arranged on both sides of the conveying path. This solution allows in particular a more effective use of the magnetic forces and results in a more continuous conveying procedure altogether.

It is an advantage here if in the secondary part, which may be a workpiece carrier or a pallet, short circuit windings are fitted. By means of short circuit windings then the magnetic forces are used for the conveying of the secondary part itself along the conveying path.

According to the invention it has been found that it is an advantage if a surface of the secondary part has profilings which offer, in co-operation with the magnetic field(s) of the primary part, the conveying force for conveying the conveying means according to the principle of the attraction of ferromagnetic materials.

A development of the invention is characterised by the fact that the secondary part has at least one permanent-magnetic part which is designed in such a way that it can be engaged and disengaged. By means of this embodiment it is possible that, during the machining in the machining station, the permanent-magnetic part can be engaged, respectively disengaged, in order to avoid that occurring chips are then picked up by the permanent-magnetic part.

The invention is characterised by the fact that the conveying device can be subdivided into different fields or sectors along the conveying path, respectively the transfer path. By means of this subdivision then a different selection of certain regions of the conveying device on the conveying path is possible.

It is another advantage here if at least one coil forming a magnetic field is assigned to each sector.

According to the invention it has also been found to be an advantage if the magnetic fields can be switched on, respectively off, separately and/or together. By means of that the linear drive can be controlled.

In the invention it is also provided that the magnetic fields are formed by several windings which can be switched on and off. By means of an overlapping of the magnetic fields also a control of the linear drive is reached, for example for every section per sector.

Furthermore it is provided that by means of different numbers of windings different magnetic intensities are available.

All variants of solutions described above have the aim to create, within the conveying device, certain regions which can be used by different magnetic fields, respectively forces, for different conveying speeds for the conveying of workpieces and/or positioning.

A development of the invention is characterised by the fact that the secondary parts are formed by sledges on which the conveying aids are arranged by means of mechanical catches, drivers or the like in such a way that they can be engaged and disengaged. This solution also serves for the purpose to convey undesired magnetic forces out of the machining station by means of disengaging of magnetic parts when the workpieces are machined on and when, for example, waste material occurs which can be magnetised.

Another aspect of the invention is also given by the fact that between the stationary primary part and the movable secondary part an air gap is formed which can be set by means of rollers and slide guides.

It is an advantage here if the rollers are, for example, profiled in order to take over the lateral guide of the conveying aids. For this purpose also guide rails may be provided into which the profilings of the rollers engage.

According to the invention it has also been found that it is an advantage if a position control is provided which consists of at least one position answering device which is arranged, for example, on the conveying aid and which co-operates with the sensors arranged at the primary part(s) and an adjustment, respectively control, device.

It is an advantage that the definition of the position of the conveying aids is carried out by means of optical distance measuring, ultra sound, inductive path measuring, Hall sensors, respectively a way measuring system. The way measuring system can here, for example, be integrated in the primary part.

The conveying device is characterised also by the fact that the position of the conveying aids relatively to the poles of the magnets of the primary part can be registered.

The definition of the position of the conveying aids can also be carried out relatively to the conveying path of the conveying device.

According to the invention it is further provided that a scanning element is arranged on the conveying aid. This scanning element can, of course, also be arranged on the conveying path, respectively at the primary part. This would then have the advantage that the conveying aid manages without an additional voltage source, respectively energy supply, for the scanning element.

According to an advantageous development of the solution according to the invention it is provided that the energy supply of the scanning element is secured by a battery, respectively an accumulator, which is arranged on the conveying aid.

The charging of the accumulator can here be carried out preferably in a waiting position along the conveying line, respectively a returning line, without contact, inductively, respectively capacitively.

According to the invention jam paths are provided in the conveying devise where conveying aids can be lined up. Jam paths like that can be used, for example, as buffers before machining stations which are just being blocked by a tool change, respectively a machining which takes longer.

Such a jam path can also be provided by the fact that there is a stopper which can be swivelled into the conveying path, respectively is designed to press the conveying means from the side to the primary part.

The conveying device according to the invention is characterised furthermore by the fact that the jam path is formed by sectors, which can be switched on and off, or by magnetic fields of the primary part which are switched on, respectively off, because of information, respectively control instructions, of the position control.

Another aspect of the conveying device is given by the fact that the conveying aids are designed in such a way that the jamming force in the transfer direction, respectively in conveying direction, of following conveying aids leads in the conveying means itself to an enlargement of the air gap between linear and secondary part.

It is an advantage here if the secondary part consists of a chassis supported on rollers which is connected flexibly via levers with the workpiece carrier, respectively the pallet.

According to the invention the enlargement of the air gap between the primary part and the secondary part of the conveying device can also be reached by providing wedge surfaces between the chassis and the workpiece carrier which are designed mounting in the direction of the transfer direction.

According to an advantageous development of the invention it is provided furthermore to arrange a running element on the workpiece carrier at the back end in conveying direction. This running element is provided in particular for the lifting of the preceding pallet, respectively the preceding workpiece carrier, in co-operation with the force of a running pallet, respectively a workpiece carrier, in order to lift it out of the region of the magnetic field.

According to the invention it is provided that the machining station or machine tool (as they will be called synonymously in the following) are designed as cutting, modifying, assembling or separating machine or the machine tool is designed as a test, mounting, adjustment, surface coating, wrapping or unwrapping, marking or cleaning station. The machine tool according to the invention is not limited at all to the machining carried out on it. All machining possibilities mentioned before require a positioning of the workpiece. Basically, the positioning of the workpiece should be carried out as time-optimised and exactly as possible which is—independently from the actual machining—solved by means of the invention. Therefore the invention can be used for any purpose of a machine tool. On the one hand it is possible that the machine tool really works on the workpiece, that means cuts, assembles or separates. In addition to that it is, however, also an advantage that the machine tool is designed as a test station in order to check, for example, corresponding machinings of a preceding machine tool. It is an advantage here to provide as early as possible suitable tests to avoid in final inspection, when a number of machinings have been carried out, the recognition that already, during an early machining an error has occurred and the complete workpiece is waste. It is also possible to design the machine tool as an assembling station. For example, it is possible to cut the thread in a boring introduced previously and then to mount in the assembling station in this thread another component. However, it is also possible to carry out, for example, in an assembling station a workpiece carrier change, that means, for example, to mount another workpiece carrier.

It is equally convenient to provide the assembling station for an exact positioning, respectively orientation, of the workpiece. Furthermore it is possible that the machine tool is designed as surface coating station. This serves, for example, for lacquering, galvanizing, printing and so on. Also wrapping and unwrapping stations are seen as machine tools, which for example wrap the workpiece after the machining is finished or unwrap it before the machining.

Furthermore also a device for marking workpieces can be provided as machine tool. In a marking station it is provided that, for example, labels or other markings, if necessary even markings which can be read electronically like bar code or transponder, are fastened or attached to the workpiece, respectively its workpiece carrier, respectively pallet, in order to identify the respective workpiece for the control. Usually here an according identification step precedes (which is, however, not compulsory).

It is convenient here also that as machining installation a cleaning station, respectively a rinsing or washing station is provided. Often workpieces are soiled during the machining, for example by means of cooling lubricants which has to be washed off just at the end of a corresponding process line. Neither is it convenient to leave corresponding oil emulsions on the workpieces if in the following a surface treatment like a lacquering or another coating shall be carried out.

The machining installations mentioned before shall be carried out as automatically operating systems or even as manual working places in the sense of the invention.

The invention provides also a production or machining line with a conveying device according to one or more of the embodiments described before which connects at least two machining stations.

### BRIEF DESCRIPTION OF THE DIFFERENT VIEWS OF THE DRAWINGS

The invention will be described in the following by means of examples and drawings: In the figures:

FIG. 1 Top view of a part of the conveying device according to the invention and

FIG. 2 example of a workpiece carrier of the conveying path.

### DETAILED DESCRIPTION OF THE PREFERRED EMBODIMENT

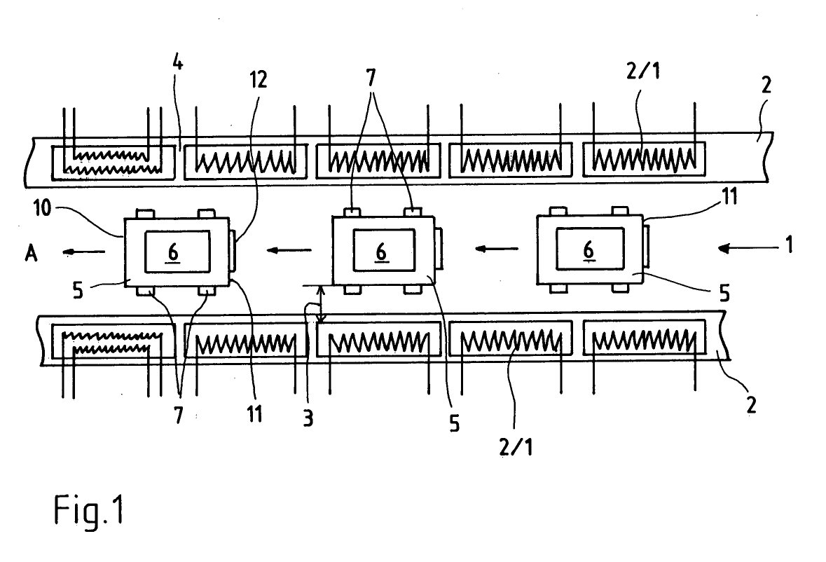

FIG. 1 shows the top view of a part of a conveying device according to the invention. The drawing has to be understood here only as a block diagram, respectively a schematic drawing. Reference number 1 indicates the conveying line here. On both sides of the conveying line 1 there is the primary part 2 which can be, for example, designed as linear part of a linear motor. On the conveying line 1 there are, in transfer direction A, the workpiece carriers 5 which carry the workpieces 6. For the adjustment of the air gap 3 between the primary part 2 and the secondary part which is, in this drawing, designed as workpiece carrier 5, rollers 7 are arranged on both sides of the workpiece carrier 5. This air gap has been denoted by the reference number 3. On, respectively in, the primary part 2 electromagnets are arranged which are designed in such a way that they can, by means of magnetic separating devices 4, be switched on, respectively off, independently. The magnetic separating devices 4 can also be designed as air gap. According to the principle of a linear motor the workpiece carriers 5 are driven on the conveying line 1 by the magnetic force of the magnetic fields of the magnets 2/1.

The advantage of the arrangement according to the invention is here that the separate magnetic fields 2/1 may have different field intensities, respectively can be impinged with different field intensities. This can be achieved, for example, with different windings which can be differently be switched on and off. Therefore, for example, also the speed can be increased on the conveying line 1 by means of switching on several windings of a magnetic field and, by means of switching off, of one or more windings, the speed can be reduced on the conveying line 1. This can be, of course, also be reached through a control of the energy supply for the magnetic fields.

By means of a complete switching off which has to be, of course, carried out on both sides of the conveying line 1 a jamming degree can be reached in such a way that then the workpiece carrier 5 does no longer move because the magnetic force is missing and the other following workpiece carriers then run on the end of the first workpiece carrier 5. Such a stopping device can be realised even mechanically by moving and fixing, for example, a stopper 13 into the conveying line 1. The corresponding magnetic field then has to be at least reduced. This can, for example, be reached also by an enlargement of the air gap 3.

The workpiece carriers 5 can here carry not shown short circuit windings by means of which the magnetic force is used. However, even by means of the use of the ferromagnetic features of the used material a profiling of a part of the surface of the workpiece carrier can be carried out.

The invention will be described further in the following by means of an example which is not or only partially shown in the block diagram of the FIG. 1. Along the conveying line 1 here a migrating magnetic field is installed as primary part 2 of a linear motor. The workpiece carrier 5 is the secondary part of the linear motor and can, according to another variant, even be designed as a pallet. As already mentioned the magnetic forces are used either by fitting in of short circuit windings directly in the pallet or by profiling a pallet surface, in order to reach the conveying force according to the principle of the attraction of ferromagnetic materials in the magnetic field. The advantages of this embodiment are given by the fact that the attraction acts only when the primary part is switched on. When the primary part 2 is switched off no significant rest energies are in existence in switched off machine regions. The pallets can be picked up easily from the belt as no permanent attractive powers (magnets) act.

The ferromagnetic materials in the cutting production can be mastered because the pallet itself can be designed non-magnetic in this embodiment. It can even be designed non-magnetic if it is clamped in the machining station and the conveying system in this region is switched off.

Furthermore an embodiment of the invention can be selected if it is necessary because of reasons of the size of the driving force to use pemanently activated synchronous motors. Then, according to the invention it is suggested, that the permanent magnetic part is disengaged from the pallet during the machining. For that purpose, for example, the pallet may be arranged on a sledge which is, for example, via a mechanic catch or a fixed driver in engagement with the pallet. In the machining station then the clamping movement of the clamping device is used in order to release the catch or to disengage the fixed driver so that the sledge with the permanent magnet can leave the working room.

Different speeds like accelerations and the positioning for the conveying between the machines and within the machine can be realised by means of the same conveying device and the same conveying principle. This can also be reached by means of different width of the motor in the primary part 2 or by adjustment of the winding of the magnetic coils 2/1 in the primary part 2. The winding of the magnetic coil 2/1 can even be different within a system region by region. This is, for example, indicated in FIG. 1 by the fact that a section of the primary part 2 has two magnetic coils 2/1. The air gap 3 between the primary part 2 and the conveying aid 5 is set either by rollers 7, which are arranged in, respectively on, the pallet and which either run directly on the active primary part 2 or on a plane orientated to it. The advantages of this embodiment are given by the fact that the belt neither has to be manufactured highly accurate nor has it to be orientated exactly.

If the rollers 7 are designed profiled they can take over, for example, even the side guide of the conveying aid 5. The same effect is reached by rollers arranged in the conveying line 1. In particular with conveying aids 5 with comparatively small pallet weight it is possible to guide the conveying aids 5 by means of a slide guide. Of course, also a magnetic guide of the conveying aids 5 is possible. The advantages of the solutions described above are that a wear-free conveying can be carried out without movable parts. In the current-less condition a friction contact with the conveying line 1 occurs and thus no undesired further movement.

If conveying aids 5, respectively pallets, have to be conveyed over longer distances usually no high accuracy of positioning is required. In this case the primary parts 2 are designed without position answering of the conveying aids 5, respectively workpiece carriers, to the primary part 2. This is defined according to the invention as a controlled operation without feedback. By means of that expenses for these belt sections can be saved because the necessary metrology and control engineering, sensors and the like are not necessary for these belt sections.

However, according to the invention by means of the same conveying device even an operation is possible with position control. This operation, however, is only necessary in the sections of the conveying line 1 where a high accuracy of the positioning is required or where, because of high accelerations and very unsteady kinetic resistance (for example through different mass of the workpiece or soiling of the belt by chips) during the controlled operation there is the risk that the pallet cannot follow the migrating magnetic field. This operation is called controlled operation by means of evaluation of at least one position signal of at least one conveying aid.

Therefore it is necessary for the position control to register the position of the pallet either relatively to a dimensional embodiment or relatively to the poles of the primary part 2. This registration can be carried out by optical distance measuring, ultra sound, inductive path measuring, Hall sensors, a way-measuring system which is integrated in the conveying line, respectively the guide rails.

Such a system can, of course, also be arranged as dimensional embodiment on the drive line. For that purpose it is necessary that scanning elements have to be arranged on the conveying aid 5.

If this scanning element has to be supplied with energy, this can be done out by means of a battery or an accumulator. The accumulator could be charged, for example, after every circle in a waiting position, which has been defined for that purpose, by means of contact-less, inductive transfer. Of course, this charging can even be carried out only in such a way that it is done only on demand. For that purpose then a monitoring of the charging condition monitoring would be additionally necessary which is, however, only activated on demand, for example, by a radar signal. The energy supply can be done even contact-less, inductively or capacitively. For that purpose then, for example, a conductive loop could be arranged along the conveying line 1 which is impinged with alternating current. Then a coil, where the voltage, which can be selected by means of the relation of the winding numbers, can be calliper, is arranged on the conveying aid 5.

The feedback of the actual position value of the pallet can be given contact-less also via infrared or radar. The transfer path for these transfer possibilities can also be designed bi-directional and be used for the exchange of other information. Information of this kind can be the charging condition of the accumulator, data of the identity of the workpiece carrier, respectively the pallet, or the workpiece itself. Even information, respectively data, can be transferred which concern the machining procedure or machining progress.

Alternatively the position registration system can also be reversed kinematic. This means that a dimensional embodiment as described above, is arranged on the pallet, respectively the conveying aid 5, and the scanning elements are arranged on the conveying line 1. This arrangement has the advantage that the pallet itself can be a passive element without energy supply. The disadvantage here is that a lot of scanning elements are needed. This is, however, not so significant if, according to the invention, only in certain sections of the traverse path the conveying is carried out with a position control.

The dimensional embodiment on the pallet, respectively on the conveying line, can be carried out, for example, in the form of magnetic or optical marks or by a mechanic profiling of the pallet itself. Alternatively to that also a measuring equipment with a passive pallet is provided where a defined surface on the pallet is scanned by means of a measuring beam, for example laser light.

In either of the cases described above several pallets can be conveyed in a sector of the primary part 2, respectively the conveying line, without collision. If the constant distance of the conveying aids 5, respectively the workpiece carriers, has been lost, for example by a loss of current, this can be restored on transferring to the next motor section by means of a simple, commercially available sensor technology or by means of a clever interpretation of values in the control of the primary part 2. For a restoring of the distance here at the end of each primary part 2 an approximate switch can be arranged which recognises the presence of a pallet.

For that purpose also an identification system can be provided which clearly identifies the conveying aid 5. The primary part 2 is then impinged with a low frequency so that all conveying aids 5 located on it are conveyed slowly to the next primary part 2. When the first conveying aid 5 has been passed to the next primary part 2 this can be conveyed independently from the conveying aid 5 which has remained on first primary part 2. In this way it is possible to restore the desired distance between the conveying aids 5 themselves before the passing of the next conveying aid 5.

The conveying device according to the invention even allows a lining up of conveying aids 5 within a certain part of the conveying device, respectively the conveying line 1. In order to use the conveying line 1 as a buffer store a stopper 13 is swivelled in the conveying line 1 or pressed to the conveying aid 5 from the side. At this stopper 13 then the following conveying aids 5 run on. The separation of the conveying aids 5 can here be realised after the jam path has been left, as described already above, respectively can be carried out on the passing from one primary part to the next one. On the lining up two different selection procedures are made possible by means of the conveying device according to the invention. One possibility here is the switching on, respectively off, of a part of the primary part 2 along the jam path. The primary part 2 which forms the jam path is only impinged with current during the periods of time when a conveying aid shall be passed into the jam section or shall leave it. By means of this possibility the lost performance is minimised and a jam delay, respectively acceleration, of the conveying aids 5 is made possible.

The lining up, respectively selection for the lining up, can be realised with less effort in a permanent operation with constant frequency. In this method a time-constant driving force acts on all conveying aids 5 within the jam path. The size of the driving force in the phases of the standstill and during acceleration of a leaving conveying aid depends on the constructive principle and the size of the linear motor. The process thus described is here very simple, however, has the disadvantage that in all jammed conveying aids 5 a loss of performance occurs which can lead among others to an undesired heating. Furthermore here also the power is increased which acts on the stopper 13 and, that is, with the number of the back-up conveying aids 5.

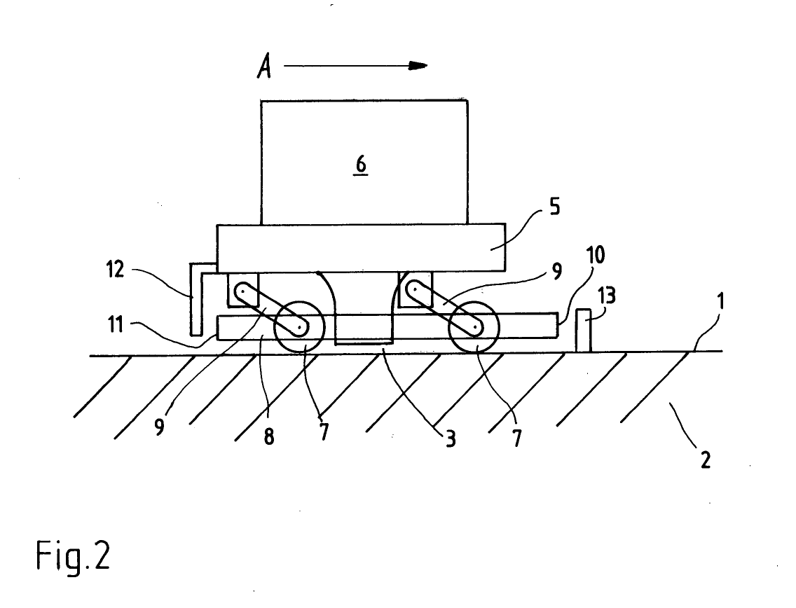

For example, the embodiment of the solution according to the invention shown in FIG. 2 serves for solving this principle.

FIG. 2 shows an embodiment of a workpiece carrier 5 on the conveying line 1. This is a special embodiment which has to be understood in no way as a limitation. Quite the reverse, by means of this embodiment it should be shown which possibilities are available by means of the conveying device according to the invention altogether. The drawing shows also a basic position in a side view. The transfer direction again is indicated here by the arrow A. On the conveying line 1 a workpiece carrier 5 is located which is arranged in this example on a chassis 8. The chassis 8 is arranged on rollers 7 and has a front running surface 10 and a back running surface 11. The actual workpiece carrier 5 is carried by the chassis 8. This workpiece carrier 5 is supported via levers 9 on the chassis 8 in such a way that it can be rotated, respectively swivelled. If now another workpiece carrier 5 runs on from the back, seen in the conveying direction, on the workpiece carrier 5, it jams into the running element 12 which is provided in this embodiment at the back end of the workpiece carrier 5. By means of the kinetic energy of the next workpiece carrier 5, respectively the workpiece 6, the workpiece carrier 5, which precedes seen in the conveying direction, is lifted by means of the swivelling arrangement of the workpiece carrier 5 via the levers 9 with regard to the chassis 8. By means of that the air gap 3 between the conveying path 1 and the workpiece carrier 5, respectively the secondary part, is enlarged. By means of that the workpiece carrier 5 leaves the field of force of the magnetic field and therefore cannot act any transverse force on the workpiece carrier 5, respectively the chassis 8. This is achieved, for example, by a stopper 13, which is not shown in FIG. 2, which is guided, respectively pushed, in the conveying path.

The embodiment of FIG. 2 described above is suggested as sub-variant of the solution according to the invention where the conveying aids 5, respectively the workpiece carriers, are designed in such a way that the jamming force of a following workpiece carrier 5 in the workpiece carrier arranged before leads to an enlargement of the air gap between the primary part 2 and the secondary part. In the embodiment described according to FIG. 2 as before a driving force which is, however, reduced acts on each conveying aid 5 within the jam path. The optional running element 12 fastened to the workpiece carrier 5 is provided in particular for the support of the lifting of the workpiece carrier 5, if a conveying means 5, which runs, seen in the conveying direction, from the back, makes the lifting of the conveying aid which is in front, respectively workpiece carrier, easier. In this way in a longer jam path the conveying aids 5, which are seen in the front in the transfer direction A, can be lifted so far that these conveying aids 5 become free of any driving force. If the conveying aid 5 at the very front in the jam path is released by the stopper 13 this conveying aid 5 is lowered again to the conveying path 1. This is given by the fact that by means of the lifting of the conveying aid 5 a resistance is necessary in the transfer direction A in the front of the chassis 8 which can be left out when the stopper 13 is swivelled away. By means of that a resistance force is built up again.

Although the invention has been described by exact examples which are illustrated in the most extensive detail, it is pointed out that this serves only for illustration and that the invention is not necessarily limited to it because alternative embodiments and methods become clear for experts in view of the disclosure. Accordingly changes can be considered which can be made without departing from the contents of the described invention.

1. Conveying device for a production or machining line with at least one, in particular cutting, machining station, the conveying device serving for the conveying of workpieces with conveying aids (5), like pallets and workpiece carriers, a primary part (2) of a linear motor being provided along the conveying path which creates a magnetic field and the conveying aid (5) being formed by the secondary part of the linear motor.

2. Conveying device according to claim 1, characterised in that the conveying device serves for a conveying of the workpieces (6) between the different machining stations as well as for a positioning of the workpiece (6) in the machining station.

3. Conveying device according to claim 1, characterised in that the conveying device serves also for a movement of the workpiece (6) in the machining station during the machining.

4. Conveying device according to claim 1, characterized in that the primary part (2) creating the magnetic field is arranged on both sides of the conveying line (1).

5. Conveying device according to claim 1, characterized in that short circuit windings are fitted in the secondary part.

6. Conveying device according to claim 1, characterized in that a surface of the secondary part has profilings which in the co-operation with the magnetic field(s) of the primary part (2) provide the conveying force for the movement of the conveying aid (5).

7. Conveying device according to claim 1, characterised in that the secondary part has at least one permanent magnetic part which can be engaged and disengaged.

8. Conveying device according to claim 1, characterised in that the conveying device can be subdivided into different sectors along the conveying path of the conveying line (1).

9. Conveying device according to claim 1, characterised in that the conveying device can be subdivided into different sectors along the conveying path of the conveying line (1) and at least one coil (2/1) forming a magnetic field is assigned to each sector.

10. Conveying device according to claim 1, characterised in that the conveying device can be subdivided into different sectors along the conveying path of the conveying line (1) and at least one coil (2/1) which forms a magnetic field is assigned to each sector and the magnetic fields can be separately switched on, respectively off.

11. Conveying device according to claim 1, characterised in that the conveying device can be subdivided into different sectors along the conveying path of the conveying line (1) and at least one coil (2/1) forming a magnetic field is assigned to each sector and the magnetic fields can be switched on, respectively off, together.

12. Conveying device according to claim 1, characterised in that the conveying device can be subdivided into different sectors along the conveying path of the conveying line (1) and at least one coil (2/1) forming a magnetic field is assigned to each sector and the magnetic fields are formed by several windings which can be switched on and off.

13. Conveying device according to claim 1, characterised in that the conveying device can be subdivided into different sectors along the conveying path of the conveying line (1) and at least one coil (2/1) forming a magnetic field is assigned to each sector and different windings provide different magnetic field intensities.

14. Conveying device according to claim 1, characterized in that the secondary parts are formed by sledges on which the conveying aids (5) are arranged by means of mechanic catches, drivers and the like in such a way that they can be engaged and disengaged.

15. Conveying device according to claim 1, characterized in that between the stationary primary part (2) and the movable secondary part an air gap (3) is formed which is set by rollers (7) or slide guides.

16. Conveying device according to claim 1, characterized in that between the stationary primary part (2) and the movable secondary part an air gap (3) is formed which is set by rollers (7) or slide guides and the rollers (7) are designed in a profiled way in order to take over the lateral guide of the conveying aids (5).

17. Conveying device according to claim 1, characterised in that a position control is provided, comprising at least one position answering device which is arranged on the conveying aid (5) and with sensors arranged on the primary part(s) and an adjustment device, respectively control device.

18. Conveying device according to claim 1, characterised in that the definition of the position of the conveying aids (5) is carried out by means of optical distance measuring, ultrasound or inductive way measuring, Hall sensors, respectively a way measuring system which is integrated in the primary part (2).

19. Conveying device according to claim 1, characterised in that the position of the conveying aids (5) can be registered relatively to the poles of the magnets of the primary part (2).

20. Conveying device according to claim 1, characterised in that the definition of the position of the conveying aids (5) is carried out relatively to the conveying line (1) of the conveying device.

21. Conveying device according to claim 1, characterised in that at least one scanning element is provided which is arranged on the conveying aid (5).

22. Conveying device according to claim 1, characterised in that at least one scanning element is provided which is arranged on the conveying aid (5) and the supply of energy of the scanning element is secured by a battery, respectively an accumulator, which is arranged on the conveying aid (5).

23. Conveying element according to claim 1, characterised in that at least one scanning element is provided which is arranged on the conveying aid (5) and the energy supply of the scanning element is secured by a battery, respectively an accumulator, which is arranged on the conveying aid (5) and the charging of the accumulator for the scanning element is carried out preferably in a waiting position contact-less inductively, respectively capacitively.

24. Conveying device according to claim 1, characterised in that jam paths where the conveying aids (5) can be lined up are provided in the conveying device.

25. Conveying device according to claim 1, characterised in that a stopper (13) is provided which is designed to be swivelled into the conveying line (1), respectively to press the conveying means (5) from the side to the primary part (2).

26. Conveying device according to claim 1, characterised in that in the conveying device jam paths are provided where the conveying aids (5) can be lined up and the jam path is formed by sectors or magnetic fields of the primary part (2) which can be switched on and off, which are, because of information, respectively control instructions, of the position control switched on, respectively off.

27. Conveying device according to claim 1, characterized in that the conveying aids (5) are designed in such a way that the jamming force in the direction of transfer (A) of following conveying aids (5) leads in the conveying aid (5) itself to the enlargement of the air gap (3) between the linear and secondary part.

28. Conveying device according to claim 1, characterized in that the secondary part consists of a chassis (8) carried by rollers (7) which is connected flexibly via levers (9) with the workpiece carrier, respectively the pallet.

29. Conveying device according to claim 1, characterised in that wedge surfaces are provided between a chassis (8) and workpiece carrier which are designed mounting in the direction of the transfer direction (A).

30. Conveying device according to claim 1, characterised in that the workpiece carrier in transfer direction (A) on the back end (1) a running element (12) is provided.

31. Conveying device according to claim 1, characterised in that the machining station (1) is designed as cutting, modifying, assembling or separating machine or the machining station (1) is designed as test station, assembling station, adjusting station, surface coating station, wrapping or unpacking station, marking station or cleaning station.

32. Production or machining line with a conveying device according to claim 1 which connects at least two machining stations.
